(19) United States
(12) Patent Application Publication
(10) Pub. No.: US 2017/0201205 A1
(43) Pub. Date: Jul. 13, 2017

(54) PHOTOVOLTAIC DEVICES WITH SEALANT LAYER AND LAMINATE ASSEMBLY FOR IMPROVED WET INSULATION RESISTANCE

(71) Applicant: Dow Global Technologies LLC, Midland, MI (US)

(72) Inventors: Ryan S. GASTON, Midland, MI (US); Leonardo C. LOPEZ, Midland, MI (US); John C. McKEEN, Hope, MI (US); Narayan RAMESH, Pearland, TX (US); Jason A. REESE, Auburn, MI (US); Jie FENG, Midland, MI (US); Ankur KHARE, Mt. Pleasant, MI (US)

(21) Appl. No.: 15/320,960

(22) PCT Filed: May 26, 2015
(86) PCT No.: PCT/US2015/032378

§ 371 Date: Dec. 21, 2016

Related U.S. Application Data
(60) Provisional application No. 62/017,425, filed on Jun. 26, 2014.

(51) Int. Cl. H02S 20/25; H02S 30/10; H01R 13/52; H02S 40/36

(52) U.S. Cl. CPC H02S 20/25; H02S 40/36; H02S 30/10; H01R 13/5202

(57) ABSTRACT

Photovoltaic Devices with Sealant Layer and Laminate Assembly for Improved Wet Insulation Resistance A photovoltaic device comprising: a polymeric frame; one or more photovoltaic cells that include one or more electric circus assemblies; one or more connector assemblies comprising: (I) one or more terminals (24), (ii) a connector body disposed about the one or more terminals, and (iii) a sealant layer (28) that is disposed about the connector body (26); wherein the one or more connector assemblies are in electrical communication with the one or more electric circuit assemblies and the one or more electronic circuit assemblies are at least partially encased in the polymeric frame; and wherein the sealant layer has sufficient heat resistance that the sealant layer will not reflow during lamination and/or injection molding.

### FIELD

The present teachings relate to an improved connector and electronic circuit assembly for improved wet insulation resistance, adhesion of components, and structural integrity of the assembly, and more particularly a sealant layer and/or insulative layer that is free of reflow during the manufacturing process,

### BACKGROUND

Building Integrated Photovoltaic Products (also known as BIPV) are exposed to significant variations in environmental loadings. They are preferably located in direct sunlight where they are subject to additional temperature loadings (beyond daily and seasonal ambient swings) due to radiant cooling and heating and may be exposed to various environmental conditions, such as rain and wind, snow and ice and other stressful environmental conditions. Such conditions can impact the ability of the systems to function as desired if certain parts are not protected from these environmental conditions for the lifetime of the product. The BIPV system design needs to address the impacts of these environmental conditions including ensuring good electrical contacts within and among components of the system.

Various testing protocols (e.g. UL 1703 Wet Insulation Resistance test (“Wet Hi-pot”)) are used to determine the product's capability to handle these temperature variations. Similarly, the environment in which the photovoltaic devices are mounted to may change as a function of temperature, humidity, or as the structure settles with time. In cases where the photovoltaic devices have integral connectors and may not be connected with wires or flexible members there is a probability of leakage paths at these integral device to device connections if not properly designed or installed. An example of available solutions is illustrated in commonly owned patent application WO 2012/044762 in which a connector and electronic circuit assembly at least partially encased in a polymeric frame and including at least a connector assembly, the contents of which are incorporated herein by reference in its entirety. Another such example, is illustrated in commonly owned patent application Ser. No. 61/861,152, filed on Aug. 1, 2013, which provides a rigid case that retains sealant material so that during the manufacturing process and/or changes in conditions the sealant material is retained at a predetermined location.

What is needed is a connector assembly that maintains its integrity and position during the manufacturing process so that the connector assembly is substantially impervious to fluid penetration, current leakage, or both. It is desirable that such assemblies and devices provide sealing about the electronic systems to prevent degradation of the systems ability to transmit electrical current, enhanced adhesion between the various components and enhanced structural stability and integrity. What is further needed is a device that is resistant to reflow so that the elements of the connector assembly remain in position during temperature changes and seal the connector assembly.

### SUMMARY

The present teachings are directed to photovoltaic devices containing connector assemblies and connector electronic circuit assemblies having enhanced sealing about electronic components, enhanced adhesion between components of dissimilar materials, enhanced structural integrity and strength, and resistance to movement and/or reflow during manufacturing or changes in temperature.

In one aspect the teachings relate to: a photovoltaic device comprising: a polymeric frame: one or more photovoltaic cells that include one or more electric circuit assemblies; one or more connector assemblies comprising: (i) one or more terminals, (ii) a connector body disposed about the one or more terminals, and (iii) one or more sealant layers that are disposed about the connector body; wherein the one or more connector assemblies are in electrical communication with the one or more electric circuit assemblies and the one or more electronic circuit assemblies are at least partially encased in the polymeric frame; and wherein the sealant layer has sufficient heat resistance that the sealant layer will not reflow during lamination and/or injection molding.

The present teachings provide a connector assembly that maintains its integrity and position during the manufacturing process so that the connector assembly is substantially impervious to fluid penetration, current leakage, or both The present teachings provide assemblies and devices that provide sealing about the electronic systems to prevent degradation of the systems ability to transmit electrical current, enhanced adhesion between the various components and enhanced structural stability and integrity. The present teachings provide a device that is resistant to reflow so that the elements of the connector assembly remain in position during temperature changes and seal the connector assembly.

### DESCRIPTION OF THE DRAWINGS

FIG. 1 illustrates a top view of an example of a photovoltaic array including a plurality of photovoltaic modules;

FIG. 2 illustrates a top view of a photovoltaic module;

FIG. 3 is an example of the electric circuit assembly of a photovoltaic module;

FIG. 4 illustrates a cross-sectional view of a terminal of FIG. 3;

FIG. 5 illustrates a cross-sectional view of another terminal of FIG. 4;

FIG. 6 illustrates a cross-sectional view of a sealant layer; and

FIG. 7 illustrates a longitudinal cross-sectional view of a connector of FIG. 3.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

A plurality of photovoltaic modules and/or photovoltaic components (i.e., solar components) of the teachings herein are combined together to form a photovoltaic array (also sometimes referred to as a solar array). The photovoltaic array collects sunlight and converts the sunlight to electricity. Generally, each of the photovoltaic modules may be individually placed in a structure that houses all of the photovoltaic modules forming all or a portion of a photovoltaic array. The photovoltaic modules of the teachings herein may be used with a housing that contains all of the individual photovoltaic modules that make up a photovoltaic array. Preferably, the photovoltaic array taught herein is free of a separate structure that houses all of the photovoltaic modules that make up a photovoltaic array. More preferably, each individual photovoltaic module may be connected directly to a structure and each of the individual photovoltaic modules is electrically connected together so that a photovoltaic array is formed (i.e., a building integrated photovoltaic (BIPV)). Each of the photovoltaic components, and preferably each row of photovoltaic components in the photovoltaic array may be adjacent to each other in a first direction. For example, if a photovoltaic array includes three rows of photovoltaic components and each row includes 5 photovoltaic components, each of the rows and each of the 5 photovoltaic components within the rows may extend along a first direction. The first direction may be aligned with the slope of a roof. Preferably, the first direction is a transverse direction (i.e., perpendicular to the slope of the roof). A portion of each of the photovoltaic modules may overlap a portion of one or more adjacent photovoltaic modules, an adjacent photovoltaic component, or both forming a shingle configuration and/or a double overlap configuration on a support structure (i.e., a support portion) so that the photovoltaic modules may be used as roofing shingles. Preferably, at least a portion of one photovoltaic component is in contact with one or more adjacent photovoltaic components so that a contiguous surface is formed, the photovoltaic components are interconnected, or both. In another preferred embodiment the photovoltaic modules of each row are offset with respect to the photovoltaic module of the next adjacent row. In this embodiment a number of photovoltaic modules contact two photovoltaic modules of the next adjacent row. An array may further comprise edge components (e.g., an integrated flashing piece) along the vertical edge of an array so as to provide a more aesthetically pleasing arrangement, that is even vertical edges of the array where the devices are offset. Such edge components may also function to connect adjacent rows electronically. Such edge components and arrays are disclosed in US Patent Applications 2011/0100436 and WO 2009/137,352 incorporated herein by reference in their entirety.

The photovoltaic components of the photovoltaic array function to collect sunlight to generate electricity, transfer power generated throughout the photovoltaic array, or both. The photovoltaic components may be a photovoltaic module, any component that assists in generating energy from sunlight, an integrated flashing piece, an inverter connection, an inverter, a connector, or a combination thereof. Preferably, the photovoltaic components are a photovoltaic module, an integrated flashing piece, or both. More preferably, at least one of two or more photovoltaic components is a photovoltaic module. The photovoltaic components may include a laminate assembly, an electric circuit assembly, a photovoltaic housing, or a combination thereof. The photovoltaic components may be connected together by a connector component that is discrete from each photovoltaic component, integrally connected to one photovoltaic component and separate from another photovoltaic component, partially integrally connected to each photovoltaic component, or a combination thereof. Preferably, the photovoltaic components each include one or more connectors so that two or more adjacent and/or juxtaposed photovoltaic components may be electrically connected together. For example, the two adjacent photovoltaic components may be located in dose proximity to each other (i.e., a spacer, gap, shim, or the like may be located between the two adjacent photovoltaic components) so that a connector may span between and electrically connect the two adjacent photovoltaic components. The connector may be a separate component that extends into an integral connector assembly and/or terminal of a photovoltaic device. For example, each photovoltaic module may include a female connector on each side and a male connector may extend into each female connector forming an electrical and mechanical connection between two adjacent photovoltaic devices. As discussed herein the connector is part of the photovoltaic devices that extends between two adjacent photovoltaic devices to assist in forming a connection. The connector may be an integral part of a photovoltaic device. The connector may be discrete from the photovoltaic devices. For example, the connector may include a male portion that projects from the photovoltaic device and the male portion may form the connection with an adjacent photovoltaic device. The photovoltaic components, adjacent photovoltaic components, or both may be the same components, different components, or combinations of photovoltaic components of the teachings herein located next to each other, side by side, juxtaposed, in a partially overlapping relationship, or a combination thereof. As discussed herein, an adjacent photovoltaic component may be any component taught herein that assists in creating a photovoltaic array so that power is generated from sunlight. The solar array may include a plurality of photovoltaic components. Preferably, at least some of the plurality of photovoltaic components are photovoltaic modules. A majority of the photovoltaic components and/or adjacent photovoltaic components in the photovoltaic array may be photovoltaic modules such that 50 percent or more, 60 percent or more, 70 percent or more, or even about 85 percent or more of the photovoltaic components are photovoltaic modules. As discussed herein a photovoltaic component and an adjacent photovoltaic component may be the same type of component just located side by side. The photovoltaic components when located side by side may form a mating connection, a physical connection, an electrical connection, or a combination thereof.

The mating connection, the physical connection, or both may be formed by one or more mating features, the connectors of the teachings herein, or both. The mating connection may be any connection where two or more photovoltaic modules are physically connected together. The mating connection may be only an electrical connection, only a physical connection, or both. The mating connection may be formed by a male portion, a female portion, or both. The male portion may be any feature and/or device that extends from one photovoltaic component to an adjacent photovoltaic component. The female portion may be any feature and/or device that receives a portion that extends from an adjacent photovoltaic component (e.g., a male portion). The mating features may be any feature that aligns the photovoltaic components, edges of the photovoltaic components, or both.

The present teachings are directed to an improved connector and electric circuit assembly that is at least partially encased in a photovoltaic module, an integrated flashing piece, or both. The present teachings may include an improved connector and electronic circuit assembly that is part of a photovoltaic device (“PV device”), for example as described in PCT Patent Application No. PCT/US2009/042523. Preferably, the photovoltaic devices are a photovoltaic module, an integrated flashing piece, or both. The photovoltaic devices may include an active portion, be free of an active portion, or a combination of both. For example, an integrated flashing piece may be free of an active portion for receiving sunlight and converting the sunlight to power and a photovoltaic module may include an active portion for generating power. The photovoltaic module may comprise a multi layer laminate structure that is at least partially encased in a polymeric frame, polymeric housing, or both. The polymeric frame may be formed about the photovoltaic cell or cells via an over-molding process, a lamination process, or a combination of both. The polymeric frame may extend only behind the photovoltaic cells, around one or more sides of the photovoltaic cells, around one or more edges of the photovoltaic cells, may form a layer that supports the photovoltaic cells, extends from the cells and forms the support portion, or a combination thereof. The polymeric frame may extend along one or more edges of the active portion, one or more sides of the active portion, behind the active portion, from an edge of the active portion and form an inactive portion, or a combination thereof. The frame may extend around a periphery of the active portion. The frame may support the photovoltaic cells, the electric circuit assembly, or both. The improved connector and electronic circuit assembly is electrically connected to one or more of the photovoltaic cells, the electric circuit assembly, or both. These components may be assembled as part of the multi-layer laminate structure. The photovoltaic modules are preferably designed to look like standard roofing materials and can be disposed on the same structure as standard roofing materials. Preferably the photovoltaic modules can be attached to a structure in the same manner as standard roofing materials. For instance the photovoltaic modules can have the appearance of roofing shingles or tiles and can be attached to a structure in the same manner. When the photovoltaic modules are designed to function in the same manner as shingles, such devices can be attached directly to a roof or sheathing element over a roof using standard fastening systems such as nails, screws, staples, adhesives and the like.

In a preferred embodiment the photovoltaic modules of the teachings comprise a multilayer laminate structure. The multi-layer laminate structure, may include a plurality of individual layers (e.g. first layer, second layer, third layer, or more) which are at least partially bonded together to form the multi-layer laminate structure. In the assembled multi-layer laminate structure, any given layer may at least partially interact/interface with more than just its adjacent layer (e.g. first layer may interact/interface at least partially with the third layer). Each individual layer may be defined as having a height, length and width, and thus a volume. Each layer may also have a profile that is consistent along its height, length or width or may be variable therein. Each layer may have top, bottom, and interposed side surfaces. Each individual layer may be monolithic in nature or may itself be a multi-layer construction or an assembly of constituent components. Various layer construction/compositions embodiments are discussed below Any layer of the multi-layer laminate structure may contain any or none of the materials or assemblies discussed herein. In other words, any particular layer may be part of any of the layers of the multi-layer laminate structure.

One or more of the layers may function as an environmental shield (“shield layer”), for the multi-layer laminate structure generally, and more particularly as an environmental shield for the successive layers. This layer may function to protect one or more of the other layers from exposure to the elements or any material that can damage other layers or interfere in the other layers ability to function as desired. This layer is preferably constructed of a transparent or translucent material that allows light energy to pass through to at least one underlying layer. This material may be flexible (e.g. a thin polymeric film, a multi-layer film, glass, or glass composite) or be rigid (e.g. a thick glass or Plexiglas™ such as polycarbonate, an alkali-aluminosilicate, or both). The material may also be characterized by being resistant to moisture/particle penetration or build up. The environmental shield layer may also function to filter certain wavelengths of light such that preferred wavelengths may readily reach the opposite side of that layer, e.g. photovoltaic cells below the shield layer. The environmental shield layer may also function as a dielectric layer to provide electrical insulation between the electrically active materials contained within the multi-layer laminate structure and the environment so as to provide protection to both the electrically active materials and externally interfacing elements. In a preferred embodiment, the environmental shield layer (first) layer material will also range in thickness from about 0.05 mm to 10 mm, more preferably from about 0.5 mm to 5 mm, and most preferably from about 3 mm to 4 mm. Other physical characteristics, at least in the case of a film, may include: a tensile strength of greater than 20 MPa (as measured by JIS K7127: JSA JIS K 7127 Testing Method for Tensile Properties of Plastic Films and Sheets published in 1989): tensile elongation of 1% or greater (as measured by JIS K7127): and water absorption (23° C., 24 hours) of 0.05% or less (as measured per ASTM D570 -98(2005)).

In a preferred embodiment, one or more of the layers may serve as a bonding mechanism (bonding layer), helping hold some or all of any adjacent layers together. In some case (although not always), it should also allow the transmission of a desirous amount and type of light energy to reach adjacent layers. The one or more bonding layers may also function to compensate for irregularities in geometry of the adjoining layers or translated through those layers (e.g. thickness changes). The one or more bonding Layers also may serve to allow flexure and movement between layers due to temperature change and physical movement and bending, in a preferred embodiment, the one or more bonding layers may comprise an adhesive film or mesh, preferably an olefin (especially functionalized olefins such as silane grafted olefins), EVA (ethylene-vinyl-acetate), silicone, PVB (poly-vinyl-butyral), (polyurethanes) similar material, or a combination thereof. The preferred thickness of this layer range from about 0.1 mm to 1.0 mm, more preferably from about 0.2 mm to 0.8 mm, and most preferably from about 0.25 mm to 0.5 mm.

One or more of the layers may serve as a second environmental protection layer (back sheet layers). The one or more back layer sheets, for example, may be to keep out moisture and/or particulate matter from the layers above (or below if there are additional layers). The one or more back layers may be constructed of a flexible material (e.g. a thin polymeric film, a metal foil, a multi-layer film, a rubber sheet, or a combination thereof). In a preferred embodiment, the back sheet material may be moisture impermeable and also range in thickness from about 0.05 mm to 10.0 mm, more preferably from about 0.1 mm to 4.0 mm, and most preferably from about 0.2 mm to 0.8 mm. Other physical characteristics may include: an elongation break of about 20% or greater (as measured by ASTM D882-09); tensile strength of about 25 MPa or greater (as measured by ASTM D882-09); and tear strength of about 70 kN/m or greater (as measured with the Graves Method). Examples of preferred materials include glass plate, PET, aluminum foil, Tedlar® (a trademark of DuPont) or a combination thereof.

One or more of the layers may function as dielectric layers. These layers may be integrated into other layers or exist as independent layers. The function of these layers may be to provide electrical separation between the electrically active materials contained within the multi-layer laminate system and other electrically active materials also within the multi-layer laminate system, or elements outside of the multi-layer laminate system. These dielectric layers may also reduce the requirements of other materials in the photovoltaic module, such as the polymeric frame, first environmental barrier, or second environmental protection layer. In the preferred embodiment, these layers have a RTI (Relative Thermal index) as determined by the test procedure detailed in UL 746B. These dielectric layers may be constructed of materials such as nylon, polycarbonate, phenolic, polyetheretherketone, polyethylene terephthalate other known dielectrics, or a combination thereof.

One or more of the layers may act an additional barrier layer (supplemental barrier layer), protecting the adjoining layers above from environmental conditions and from physical damage that may be caused by any features of the structure on which the multi-layer laminate structure is subjected to (e.g. for example, irregularities in a roof deck, protruding objects or the like). A supplemental barrier layer may provide other functions, such as thermal barriers, thermal conductors, adhesive function, dielectric layer, the like, or a combination thereof. The supplemental barrier layer may be a single material or a combination of several materials, for example, the supplemental barrier layer may include a scrim or a reinforcing material. Preferably, the supplemental barrier layer may be at least partially moisture impermeable and also range in thickness from about 0.25 mm to 10.0 mm, more preferably from about 0.5 mm to 2.0 mm, and most preferably from about 0.8 mm to 1.2 mm It is preferred that this layer exhibit elongation at break of about 20% or greater (as measured by ASTM D882-09); tensile strength or about 10 MPa or greater (as measured by ASTM D882-09); and tear strength of about 35 kN/m or greater (as measured with the Graves Method). Examples of preferred barrier layer materials include thermoplastic polyolefin (“TPO”), thermoplastic elastomer, olefin block copolymers (“OBC”), natural rubbers, synthetic rubbers, polyvinyl chloride, and other elastomeric and plastomeric materials. Alternately the protective layer could be comprised of more rigid materials so as to provide additional structural and environmental protection. Additional rigidity may be desirable so as to improve the coefficient of thermal expansion of the multi-layer laminate structure and maintain the desired dimensions during temperature fluctuations. Examples of protective layer materials for structural properties include polymeric materials such polyolefins, polyester amides, polysulfone, acetel, acrylic, polyvinyl chloride, nylon, polycarbonate, phenolic, polyetheretherketone, polyethylene terephthalate, epoxies, including glass and mineral filled composites, or any combination thereof.

One or more of the layers may be constructed of any number of photovoltaic cells or connected cell assemblies. The photovoltaic cell and/or cell assemblies may be made of any material that functions to convert solar energy to electrical energy may be utilized herein. The electronic circuit assembly is part of this layer of the multi-laminate structure and is further described in following sections of this disclosure. The electronic circuit assembly is connected to the connector assembly so as to facilitate transfer of the electrical energy generated by the photovoltaic cells to other components of the system, for instance other photovoltaic modules, edge elements, wiring adapted for transporting the electrical energy to an inverter, or a combination thereof.

Photovoltaic cells or cell assemblies function to convert light energy into electrical energy and transfer the energy to and from the device via connector assemblies. The photoactive portion of the photovoltaic cells may comprise material which converts light energy to electrical energy. Examples of such material includes crystalline silicon, amorphous silicon, CdTe, GaAs, dye-sensitized solar cells (so- called Gratezel cells), organic/polymer solar cells, or any other material that converts sunlight into electricity via the photoelectric effect. Preferably the photoactive layer comprises IB-IIIA-chalcogenide, such as IB-IIIA-selenides, IB-IIIA-sulfides, or IB-IIIA-selenide sulfides. More specific examples include copper indium selenides, copper indium gallium selenides, copper gallium selenides, copper indium sulfides, copper indium gallium sulfides, copper gallium selenides, copper indium sulfide selenides, copper gallium sulfide selenides, and copper indium gallium sulfide selenides (all of which are referred to herein as CIGSS). These can also be represented by the formula CuIn(1−x)GaxSe(2−y)Sy where x is 0 to 1 and y is 0 to:2. The copper indium selenides and copper indium gallium selenides are preferred. Additional electroactive layers such as one or more of emitter (buffer) layers, conductive layers (e.g. transparent conductive layers) and the like as is known in the art to be useful in CIGSS based cells are also contemplated herein. These cells may be flexible or rigid and come in a variety of shapes and sizes, but generally are fragile and subject to environmental degradation. The photovoltaic cell assembly is a cell that can bend without substantial cracking and/or without significant loss of functionality. Exemplary photovoltaic cells are taught and described in a number of patents and publications, including U.S. Pat. No. 3,767,471, U.S. Pat. No. 4,465,575, US20050011550A1, EP841706A2, US20070256734A1, EP1032051A2, JP2216874, JP2143468, and JP10189924A, all of which are incorporated by reference herein in their entirety for all purposes.

The photovoltaic modules comprise a frame that functions to contain one or more components of the structure without interfering with the ability of the photovoltaic cells to convert solar energy to electrical energy. The frame may function as the main structural carrier for the photovoltaic module and may be constructed in a manner consistent with this. For example, the frame can essentially function as a polymeric framing material. The frame may function to hold some or all of the parts of the photovoltaic structure together. The frame may function to encapsulate and protect certain parts of the structure. The frame may extend along one or more sides, one or more edges, or both of the cells of the photovoltaic module. The frame may extend around a periphery of the cells. The frame may extend along a single side and/or edge of the frame. The frame is preferably flexible and allows the photovoltaic modules to conform to the irregularities of building surfaces. The polymeric frame may form the structure by which the device can be attached to a structure. The frame may be the base structure such that the photovoltaic module appears and functions like a roofing shingle or tile. The frame may be a compilation of components/assemblies, but is preferably generally a polymeric article that is formed by a fabrication technique that facilitates forming a structure that achieves the recited functions. The frame can be formed by injection molding, compression molding, reaction injection molding, resin transfer molding, thermal forming, and the like. Preferably the polymeric frame can be formed by injecting a polymer (or polymer blend) into a mold (with or without inserts such as the multi-layer laminate structure or the other component(s), for example as disclosed in WO 2009/137,348, incorporated herein by reference.

The frame has a coefficient of linear thermal expansion (CLTE) and the CLTE of the frame may closely match one or more parts of the photovoltaic devices. Preferably, the CLTE of the frame composition closely matches the CLTE of other layers of the system for instance the environmental protective layer (or in some cases of the entire structure). Preferably the compositions that make up the frame exhibit a CLTE of about 0.5×10−6 mm/mm ° C. to about 140×10−6 mm/mm ° C. preferably of about 3×10−6 mm/mm ° C. to about 50×10−6 mm/mm ° C., more preferably from about 5×10−6 mm/mm ° C. to about 30×10−6 mm/mm ° C., and most preferably from about 7×10−6 mm/mm ° C. to about 25×10−6 mm/mm ° C. Preferably the CLTE of the composition making up the frame disclosed herein are also characterized by a CLTE that is within factor of 20, more preferably within a factor of 15, still more preferably within a factor of 10, even more preferably within a factor of 5, and most preferably within a factor of 2 of the CLTE of the protective layer (or entire structure). For example, if the environmental protective layer has a CLTE of 9×10−6 mm/mm ° C., then the CLTE of the polymeric frame composition is preferably from 180×106 mm/mm ° C. to 0.45×10−6 mm/mm ° C. (a factor of 20); more preferably from 135×10−6 mm/mm ° C. to 0.6×10−6 mm/mm DC (a factor of 15); still more preferably from 90×10−6 mm/mm ° C. to 0.9×10−6 mm/mm ° C. (a factor of 10); even more preferably from 45×10−6 mm/mm ° C. to 1.8×10−6 ° C. (a factor of 5) and most preferably from 18×10−6 mm/mm ° C. to 4.5×10−6 mm/mm ° C. (a factor of 2).

For some embodiments of the photovoltaic modules disclosed herein, the environmental shield layer comprises a glass barrier layer. If the photovoltaic modules include a glass layer, the CLTE of the polymeric frame composition is preferably less than 80×10−6 mm/mm ° C., more preferably less than 70×10−6 mm/mm ° C., still more preferably less than 50×10−6 mm/mm ° C., and most preferably less than 30×10−6 mm/mm ° C. Preferably, the CLTE of the polymeric frame composition is greater than 5×10−6 mm/mm ° C.

The frame may comprise a filled or unfilled moldable polymeric material. Exemplary polymeric materials include polyolefins, styrene acrylonitrile (SAN) (acrylonitrile butadiene styrene, hydrogenated styrene butadiene rubbers, polyester amides, polyether imide, polysulfone, acetel, acrylic, polyvinyl chloride, nylon, polyethylene terephthalate, polycarbonate, thermoplastic and thermoset polyurethanes, synthetic and natural rubbers, epoxies, acrylics, polystyrene, or any combination thereof. Fillers (preferably up to about 50% by weight) may include one or more of the following; colorants, fire retardant (FR) or ignition resistant (IR) materials, reinforcing materials, such as glass or mineral fibers, surface modifiers. The polymeric materials may also include anti-oxidants, release agents, blowing agents, and other common plastic additives. In a preferred embodiment, glass fiber filler is used. The glass fiber preferably has a fiber length (after molding) ranging from about 0.1 mm to about 2.5 mm with an average glass length ranging from about 0.7mm to 1.2 mm.

The polymeric frame materials may exhibit a melt flow rate of about 5 g/10 minutes or greater, more preferably about 10 g/10 minutes or greater. The melt flow rate is preferably 100 g/10 minutes or less, more preferably about 50 g/10 minutes or less and most preferably about than 30 g/10 minutes or less. The melt flow rate of compositions can be determined by test method ASTM 01238-04, “REV C Standard Test Method for Melt Flow Rates of Thermoplastics by Extrusion Plastometer”, 2004 Condition L (230° C./2.16 Kg.

The frame materials may exhibit flexural moduli of about 500 MPa or greater, more preferably about 600 MPa or greater and most preferably about 700 MPa or greater. Where the muiti-layer laminate structure includes a glass layer, the flexural modulus is preferably about 1000 MPa or greater and about 7000 MPa or less, The flexural modulus may be about 1500 MPa or less, more preferably about 1200 MPa or less, most preferably about 1000 MPa or less. The flexural modulus of frame material may be determined by test method ASTM D790-07 (2007) using a test speed of 2 mm/mm. Preferably the frame materials exhibit a coefficient of linear expansion (“body CLTE”) of about 25×10−6 mm/mm ° C. to 70×10−6 mm/mm ° C., more preferably of about 27×10−6 mm/mm ° C. to 60×10−6 mm/mm ° C., and most preferably from about 30×10−6 mm/mm ° C. to 40×10−6 mm/mm ° C.. The frame material may also be characterized as exhibiting a Young's Modulus at −40° C.=7600 MPa+/−20%; at 23° C.=4200 MPa+/−20%; and at 85° C.=2100 MPa+/−20%.

The frame materials may be characterized as having both an RTI Electrical, an RTI Mechanical Strength, and an RTI Mechanical Impact rating, each of which is about 85° C. greater, preferably about 90° C. or greater, more preferably about 95° C. or greater, still more preferably about 100° C. or greater, and most preferably about 105° C. or greater. RTI (Relative Thermal Index) is determined by the test procedure detailed in UL 7466 (Nov. 29, 2000). Because RTI is an expensive and time-consuming test, a useful proxy for guiding the skilled artisan in selecting useful compositions is the melting point, as determined by differential scanning calorimetry (DSC). It is preferred that for the compositions set forth as useful herein, no melting point is seen at temperatures less than 160° C. in differential scanning calorimetry for a significant portion of the composition and preferably no melting point is seen under 160° C. for the entire composition. The Differential Scanning calorimetry profiles were determined by test method ASTM D7426-08 (2008) with a heating rate of 10° C./min. If a significant fraction of the injection molding composition melts at temperatures below 160° C., it is unlikely that the composition will pass the UL RTI tests 7466 for Electrical, Mechanical Strength, Flammability, and Mechanical Impact with a high enough rating to adequately function when used in the photovoltaic device 1000.

The frame may comprise any shapes and size that facilitates it performing its recited function. For example, the frame may be square, rectangular, triangular, oval, circular or any combination thereof. The frame may extend along one or more sides or edges of the photovoltaic devices. Preferably, the frame extends along one or more sides of a photovoltaic module. The frame may be integrally connected to the support portion, may extend from the support portion may be connected to the support portion and extend under the active portion, or a combination thereof. The frame may extend around one or more sides of the active portion of a photovoltaic module.

The shingle like structure provides an active portion and inactive portion. The active portion comprises the portion of the device having the photovoltaic cells disposed thereon and in use this portion must be uncovered so as to be exposed to solar light. The inactive portion typically comprises the portion of the device that may be affixed to a structure using standard fastening systems. The active portion of the photovoltaic devices may include an electric circuit assembly. Preferably, the photovoltaic modules comprise electronic circuit assemblies adapted to collect electrical energy generated by the photovoltaic cells and to transmit the electrical energy through the photovoltaic module. The electronic circuit assembly is connected to and/or includes connector assemblies which are adapted to connect the photovoltaic module with external devices, such as adjacent photovoltaic modules, edge sections or an electrical system adapted to transmit electrical energy for use (inverter). The electronic circuit assembly comprises conductors (e.g., ribbons, bus bars, or both) in contact with photovoltaic cells to collect and/or transport the electrical energy converted from solar energy. Preferably such conductive collectors are applied to the surface of the photovoltaic cells in a pattern. Where the photovoltaic modules comprise more than one photovoltaic cell the devices further comprise conductive connectors (e.g., ribbons) that connect the conductive collectors so as to transmit the electrical energy through the device. The electrical connector assemblies and/or connectors may be in the form of bus bars, traces, conductive foil or mesh, ribbons, the like, or a combination thereof Exemplary electronic circuit assemblies are disclosed in WO 2012/033657 and WO 2012/037191 incorporated herein by reference.

The photovoltaic devices comprise one or more connector assemblies (discussed herein as “connector assembly”). The connector assemblies may function as the conduit/bridge for electricity to move to and from the photovoltaic modules. The connector assemblies may be a female part, a male part or both. The connector assemblies may be located adjacent to the active portion. The connector assemblies may be flush with a side and/or edge of the photovoltaic device in which it is located. The connector assemblies may be located within a frame. The connector assemblies may be located adjacent to a frame. The connector assemblies may extend above or below the frame. The connector assemblies may be part of the electric circuit assembly. The connector assemblies may be electrically connected, mechanically connected, or both to the electric circuit assembly. A connector assembly on one photovoltaic device may directly connect with a connector assembly on an adjacent photovoltaic device. A connector assembly on one photovoltaic device may indirectly connect with a connector assembly on an adjacent photovoltaic device. For example, a connector may extend between the two adjacent photovoltaic devices and connect to each respective connector assemblies. The connector assemblies may include one or more exposed electrical components such as ribbons, bus bars, or both. The one or more exposed electrical components may form a terminal and the terminal may be electrically sealed, fluidly sealed, or both by one or more sealants, one or more barrier elements, or both.

The one or more terminals may be formed to create an electrical connection between one or more adjacent components so that power may be transferred from one photovoltaic device to another photovoltaic device. The terminal may be a portion of the electric circuitry (e.g., a ribbon or a bus) that extends to an outer location of the photovoltaic devices and is exposed so that the electric circuitry may be connected to another device. The terminal may be an exposed portion of the electrical circuitry. The terminal may be one or more exposed bus bars, one or more exposed ribbons, or both. The terminals may be exposed within the connector assembly. At least a portion of the terminal is located within a connector body.

The connector body may function to support the terminals, seal the terminals, prevent current leakage of the connector assemblies, prevent fluid penetration into the terminals, or a combination thereof. The connector body may substantially surround a portion of the terminals. The connector body may surround a portion of the terminals and a portion of the terminals may extend beyond the connector body and be exposed for making a connection. The connector body may form a rigid support piece that provides cantilever support for the terminals and provides a barrier so that fluid, current, or both are prevented from ingress and/or egress through the connector body. The connector body may be pre-formed and the terminals may be extended through the connector body. The connector body may be formed around the terminals so that the terminals are sealed within the connector body.

The connector body may be comprised of somewhat rigid materials that will hold up to the conditions of use. The connector body may be made of thermoplastics, thermosets, metals, ceramics, and composites. The connector body may preferably be constructed of electrically non-conductive materials (having dielectric properties) and the terminal of electrically conductive materials. Preferred non-conductive materials may be organic or inorganic materials. Examples of preferred polymeric materials include thermoplastic and thermosetting materials such as, for example, filled or unfilled olefins, styrenics, polypropylene, polycarbonate, acrylonitrile butadiene styrene, polybutylene terephthalate, polyphenylene oxide, polyphenylene ether, polyphthalamide, polyphenylene sulfide, bolyamide, polyarylamide, polymeric elastomers, natural or synthetic rubber, ceramic, or any combination thereof. Preferred conductive materials include plated or un-plated metals (e.g. silver, tin, steel, gold, aluminum, copper, brass, or any combination thereof) and/or conductive polymers. The connector body may further comprise a locating element adapted to align the connector assemblies with an external connector or device. The connector body may further comprise a securing system for holding the connector assembly and consequently the photovoltaic device to an external connector or device. Such securing system can comprise any securing system (retention aid) that performs the function of aligning an external connector or device with the connector assembly guide portion, for example grooves, ribs, snap fits, mating holes and protrusions, and the like.

The at least one terminal functions to conduct electricity through the connector body from the electronic circuit assembly to an external device. The terminal in the inboard portion overlaps and is functionally electrically connected to the electronic circuit assembly at a connection zone. The connection zone could be a single point or a span ranging from a few millimeters to a few centimeters. The electrical connection between the connector assemblies and the electronic circuit assembly may be facilitated by welding; soldering; crimping the use of conductive adhesives, the like, or a combination thereof. The one or more connector assemblies may include one or more sealant layers that cover all OF a portion of the connector, the terminal, the connector body, or a combination thereof.

The one or more sealant layers may function to prevent and/or eliminate fluid penetration into the connector assemblies. The one or more sealant layers may function to prevent and/or eliminate current, leakage from the connector assemblies, the body portion, the terminals, or a combination thereof. The one or more sealant layers may be a single layer of sealant that is applied to the connector assemblies, the connector body, or both. The sealant layer may extend around one or more sides of the connector assemblies. Preferably, the sealant layer surrounds the connector assemblies, the connector body, the terminals, or a combination thereof, The sealant layer may surround the connector assemblies so that the sealant layer forms, a fluid impenetrable layer, a current impenetrable layer, or both. The sealant layer may be wrapped round the connector assemblies so that at least a portion of the sealant layer overlaps itself. The sealant layer may have adhesive characteristics in a green state, in a cured state, or both. The sealant layer may adhere to the connector assemblies when the sealant layer is applied to the connector assemblies. The sealant layer may adhere to itself when applied to the connector assemblies so that the sealant layer is retained on the connector assemblies. The sealant layer may substantially retain its size, shape, orientation, geometry, or a combination thereof after application, during curing, during lamination, during injection molding, or a combination thereof. The sealant layer may have sufficient adhesion on both sides so that the sealant layer adheres to a frame, a housing, a connector body, a terminal, a connector assembly, an encapsulating layer, one or more surrounding lamination layers, or a combination thereof. The sealant layer may adhere between the connector body and a surrounding layer (e.g., a frame) so that fluid, current, or both are substantially prevented or prevented from entering and/or exiting the photovoltaic device through the connector assemblies. The sealant layer may have sufficient thermal stability that thermal changes do not cause the sealant material to change shape, size, orientation, or a combination thereof. The sealant layer may have sufficient thermal stability that thermal changes do not cause the sealant to reflow. For example, when the connector assemblies are subjected to an elevated temperature to cure one or more parts of the connector assemblies, the sealant layer will retain its form from the application. The sealant layer may have sufficient thermal stability to maintain shape during a lamination process, an injection molding process, a curing process, or a combination thereof (i.e., the sealant layer will not reflow).

The sealant layer may be thermally stable to a temperature of about 60° C. or more, preferably about 80° C. or more, more preferably about 100° C. or more, or even about 120° C. or more. For example, when the sealant layer is subjected to elevated temperatures of about 150° C. for 30 minutes at 1 ATM the sealant layer will not reflow, liquefy, soften, change shape, change orientation, change geometry, or a combination thereof. The sealant layer may have sufficient heat resistance so that the sealant layer will not reflow during a lamination and/or injection molding process (i.e., when exposed to a temperature of about 100° C. or more, 120° C. or more, or even 150° C. or more for a duration of about 5 minutes or more, about 10 minutes or more, or about 15 minutes or more). The sealant may function to maintain its shape, size, orientation, geometry, or a combination thereof without the assistance of any other materials and/or devices. The sealant may retain its shape without an external encasement extending partially and/or fully around the sealant layer. The sealant layer may retain its shape without any external forces and/or devices acting upon the sealant layer. The sealant layer may have a coefficient of thermal expansion that is similar to that of the materials of the photovoltaic device.

The coefficient of linear thermal expansion (CLUE) may be different than that of the surrounding material, the connector assembly, the lamination layers, or a combination thereof, but the extension characteristics of the sealant layer may accommodate for different CTE of the various layers of the photovoltaic device. For example, the sealant layer may be connected on one side to a connector body and may be connected on a second side to a frame, and the connector body and frame may expand at different rates and the sealant layer may have sufficient extension so that the sealant layer maintains a water tight, current tight, or both seal between the frame and the connector body as they move. The sealant layer at 25° C. may extend a distance of about 2 mm or more, about 5 mm or more, about 7 mm or more, or even about 10 mm before the sealant layer fails (i.e., ceases to form a connection with one or more layers of the photovoltaic device and/or adjacent layers). The sealant layer at −40° C. may extend a distance of about 1 mm or more, preferably about 2 mm or more, more preferably about 2.5 mm or more, or even about 4 mm or more before the sealant layer fails. The sealant layer at 25° C. may withstand a load of about 40 N or more about 50 N or more, about 60 N or more, about 70 N or more, or even about 80 N or more before failure. The sealant layer may have an elongation break of about 100% or more, preferably about 200% or more, more preferably about 300% or more, or even more preferably about 400% or more. The elongation may result in improved fracture toughness properties.

The fracture toughness may withstand repeated thermal cycling without delamination, separation, or both. For example, the sealant layer may maintain its adhesive characteristic and maintain a connection when the photovoltaic device is repeatedly thermal cycled between temperatures of about −40° C. to about 90° C. The fracture toughness may be sufficiently high so that the sealant layer allows for movement between the frame and the connector body without stress (e.g., damage which allows for fluid penetration or current, leakage) being placed on the frame, the connector body, or both. The sealant layer may have sufficient fracture toughness so that the sealant layer prevents cohesive separation from the frame, the sealant layer, or both during repeated thermal cycling at temperatures ranging from about −40° C. to about 90° C. The sealant may maintain a substantially constant fracture toughness in a temperature range from about −40° C. to about 90° C. (e.g., the range may vary by an amount of about 15× or less, about 10× or less, or about 8× or less) when measured using the double cantilever beam fracture method (DCB). For example, if the fracture toughness is 400 J/m² at −40° C. then the fracture toughness will be about 50 J/m² at 90° C. when the fracture toughness varies by about 8×. The fracture toughness when measured from about −40° C. to about 90° C. may maintain a fracture toughness of about 40 J/m² or more, about 50 J/m⁷ or more, or preferably about 60 J/m² or more. The sealant layer may have sufficient fracture toughness, thermal expansion, elongation, modulus, or a combination thereof that the sealant layer may have a UL relative thermal index (RTI) rating of 105° C. as tested using UL746. Stated another way, the sealant layer may be temperature stable at temperatures up to about 167° C. over 1000 hours to achieve a 105° C. UL rating as tested using UL746. Examples, of suitable sealant layers are sold under the name 4411G and VHB 5919 by 3M™. The sealant layer may have sufficient shear resistance that the sealant layer may allow for movement between layers on opposing sides of the sealant layer.

The shear resistance may be the resistances discussed herein for elongation. The sealant layer may have sufficient shear resistance so that the connector assemblies are substantially free of current leakage, penetration by fluids, or both. The shear resistance may result in a reduced buildup of hydrostatic stresses, may eliminate hydrostatic stresses between the layers, or both. The sealant layer may be deformable so that one or more stresses and/or type of stresses are relieved in one or more directions (e.g., a compressive stress, a tension stress, a shear stress, or a combination thereof). For example, the sealant layer may move when a shear stress is applied so that the shear stress on the sealant layer is dissipated after an initial movement so that the stress is not built up. The sealant layer may prevent a buildup of hydrostatic stresses, may eliminate hydrostatic stresses between layers, or a combination thereof. The sealant layer may adhere without using a primer, cleaning a surface, or both.

The sealant layer may be a combination of one or more layers. For example, the entire thickness of the sealant layer may be a homogenous material. In another example, the sealant layer may include two or more materials such that one material is connected to a second material. The sealant layer may be tacky on one or both sides, in a green state, a cured state, or both at room temperature The sealant layer may include a sealant and a secondary layer on one or more sides. The secondary layer may be a low surface energy backing. The sealant layer may include a low surface energy backing, an adhesive layer, a low tack layer, or a combination thereof. The sealant layer when it includes more than one layer has at least one layer which is a sealant and at least one layer which is a low surface energy backing on one or both sides of the sealant. The sealant may be any material that functions as is discussed herein for the sealant layer.

The sealant may be a foam, a foamed material, or both. The sealant may be a foam in the green state, cured state, or both. The sealant may be an open cell foam, but preferably the sealant is a closed cell foam. The sealant may be a cross-linked material. The sealant may include acrylic. The sealant may be a cross-linked acrylic foam. The sealant may be substantially entirely made of acrylic. Preferably, the sealant may be an acrylic foam. The sealant may be an acrylic and ethylene copolymer. The sealant may be a foam that is elastically deformable. The sealant has a sufficient thickness so that the sealant is elastic, may be elongated, or both as is discussed herein. The sealant may have a thickness of about 0.5 mm or more, about 0.7 mm or more, or even about 0.9 mm or more. The sealant may include a secondary layer on one or both sides.

The secondary layer may decouple two or more layers of the photovoltaic device so that the two or more layers of the photovoltaic device are prevented from cracking, being damaged, stressed, strained, or a combination thereof. The secondary layer may function to decouple the frame from the connector body. The secondary layer may be an intermediate layer between a connector body and a molded part, between a sealant and a connector body, a sealant and a molded part, or a combination thereof. The secondary layer may function to allow two layers to move relative to each other and maintain a connection between the two layers. The secondary layer backing may function to improve bonding in a green state, in a cured state, or both (i.e., when compared to the sealant). The secondary layer backing may have a low tack (when compared to the sealant) so that the low surface energy backing does not stick to materials in the green states, allows for handling of the material without a liner, does not stick to materials in the green state, forms a releasable connection in the green state, or a combination thereof. The secondary layer backing may be free of tack, not tacky to the touch, or both at room temperature. The secondary layer may be a low surface energy backing. The secondary layer backing may be a polymer. The secondary layer backing may be silicone, a fluropolymer, an ionomer, an acrylic and ethylene copolymer, or a combination thereof. The secondary layer has a thickness. The secondary layer has a thickness of about 0.01 mm or more, preferably about 0.05 mm or more, and more preferably about 0.08 mm or more.

All or a portion of the photovoltaic modules may be connected in series, in parallel, or a combination thereof. The connector assemblies may be used to form such connections. Preferably the connector assemblies are disposed or encased in the vertical edges of the photovoltaic modules, the integrated flashing pieces, or both. The connector assembly may be laminated, injection molded, or both within the photovoltaic devices. The encased connector assemblies may connect to the encased connector assemblies of adjacent photovoltaic modules. Alternatively a separate connection element may be used to connect the connector assemblies of adjacent connector assemblies. Such arrangement can comprise a male connector or a female connector. Each photovoltaic module can have two of the same type of connectors, male or female, or one of each.

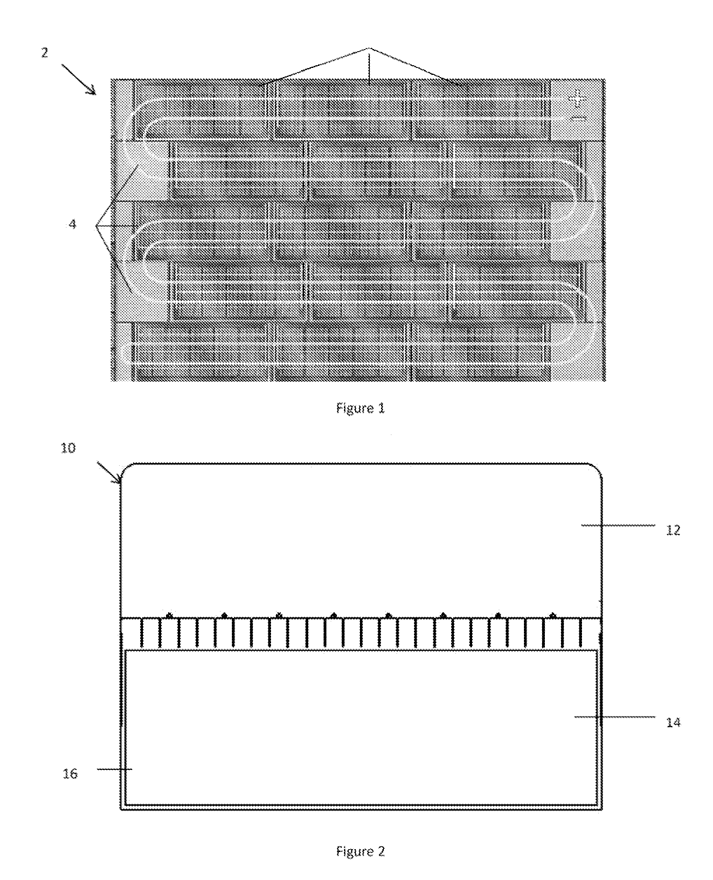

FIG. 1 illustrates a photovoltaic array 2. The photovoltaic array 2 includes a plurality of photovoltaic modules 10 that are electrically connected together in rows. The rows of photovoltaic modules 10 are electrically connected together by one or more integrated flashing pieces 4.

FIG. 2 depicts one photovoltaic module 10. The photovoltaic module 10 includes a support portion 12 and an active portion 14. The active portion 14 includes a frame 16 that extends around the active portion 14.

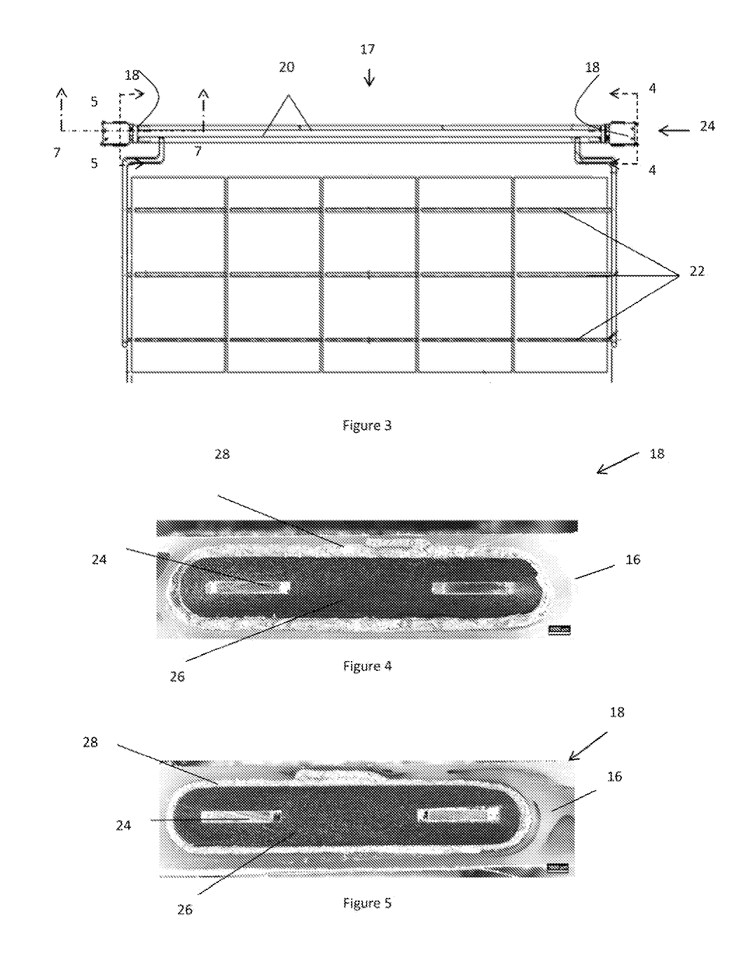

FIG. 3 illustrates err example of the electric circuit assembly 17 from the active portion of a photovoltaic module. The electric circuit assembly 17 includes a pair of generally parallel bus bars 20. The bus bars 20 are electrically connected to a plurality of ribbons 22 that extend throughout the active portion. The plurality of ribbons 22 are connected to the bus bars 20 and power flows from the plurality of ribbons 22 into the bus bars 20 and through the connectors 18. The connectors 18 include terminals 24 that electrically connect the electric circuit assembly 17 to another photovoltaic module (not shown), err integrated flashing piece (not shown), an inverter (not shown), or some other electrical component.

FIG. 4 illustrates an example of a connector 18 of FIG. 3 cut along line 4-4 The connector includes a pair of terminals 24 that are substantially encased in a connector body 26 so that the terminals 24 are electrically isolated and substantially sealed from the introduction of moisture. The connector body 26 is covered by a sealant layer 28 that further insulates both the terminals 24 and the connector body 26 from penetration by fluids and current leakage.

FIG. 5 illustrates an example of a connector 18 of FIG. 3 cut along line 5-5. The connector includes a pair of terminals 24 that are substantially encased in a connector body 26 so that the terminals 24 are electrically isolated and substantially sealed from the introduction of moisture. The connector body 26 is covered by a sealant layer 28 that further insulates both the terminals 24 and the connector body 26 from penetration by fluids and current leakage.

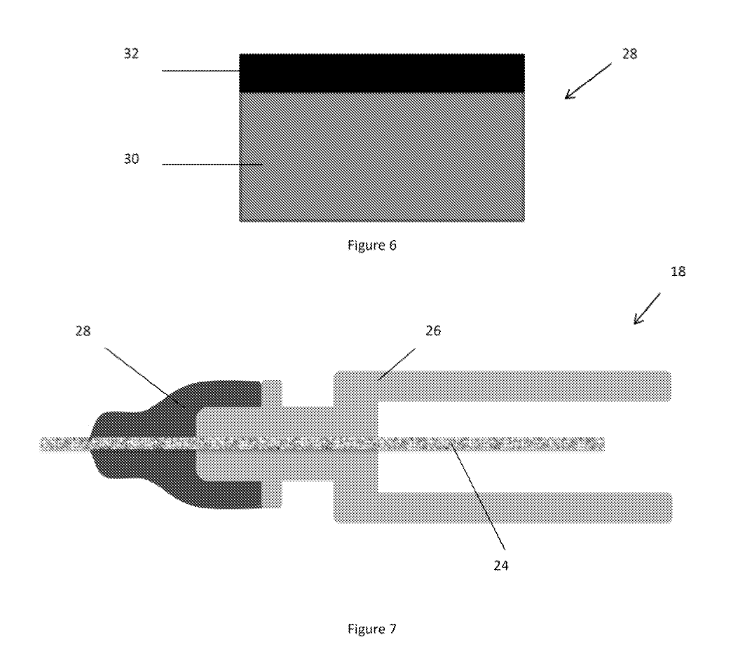

FIG. 6 illustrates a cross-sectional view of a sealant layer 28. The sealant layer 28 includes a layer of foam 30 and a secondary layer 32.

FIG. 7 illustrates a longitudinal cross-sectional view of a connector 18. The connector 18 includes a terminal 24 that extends through a component body 26 so that an electrical connection can be formed with another component. A sealant layer 28 extends over a portion of the terminal 24 and the component body 26 sealing the connector 18 so that current is prevented from leaking and fluids are prevented from penetrating into the connector 18.

Unless stated otherwise, dimensions and geometries of the various structures depicted herein are not intended to be restrictive of the teachings, and other dimensions or geometries are possible. In addition, while a feature of the present teachings may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present teachings. Therefore, the following claims should be studied to determine the true scope and content of the teachings. Unless otherwise stated, all ranges include both endpoints and all numbers between the endpoints. The use of “about” in connection with a range applies to both ends of the range.

The disclosures of all articles and references, including patent applications and publications, are incorporated by reference for all purposes. The use of the terms “comprising” or “including” to describe combinations of elements, ingredients, components or steps herein also contemplates embodiments that consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

1) A photovoltaic device comprising:
a polymeric frame;
one or more photovoltaic cells that include one or more electric circuit assemblies;
one or more connector assemblies comprising:
i) one or more terminals,
ii) a connector body disposed about the one or more terminals, and
iii) one or more sealant layers that are disposed about the connector body;
wherein the one or more connector assemblies are in electrical communication with the one or more electric circuit assemblies and the one or more electronic circuit assemblies are at least partially encased in the polymeric frame;
wherein the sealant layer is an acrylic foam; and
wherein the one or more sealant layers have sufficient heat resistance that the one or more sealant layers will not reflow during lamination and/or injection molding.

2) (canceled)

3) The photovoltaic device of claim 12, wherein the acrylic foam is a closed cell foam.

4) The photovoltaic device of claim 1, wherein the acrylic foam is covered with a secondary layer on one or more sides.

5) The photovoltaic device of claim 1, wherein the one or more connector assemblies is free of a rigid case, is free of a separate case that connects over one or more layers of the one or more connector assemblies, or both.

6) The photovoltaic device of claim 1, wherein the sealant layer maintains geometry during a lamination process, an injection molding process, or both having a temperature of about 100° C. or more for a duration of about 15 minutes or more.

7) The photovoltaic device of claim 1, wherein the sealant layer has a fracture toughness of about 40 J/m² or more at temperatures ranging from about −40° C. to about 90° C. so that the sealant layer prevents cohesive separation of the frame, the secondary layer, or both during repeated thermal cycling.

8) The photovoltaic device of claim 2, wherein the acrylic foam is a cross-linked acrylic foam.

9) The photovoltaic device of claim 4, wherein the secondary layer is a low surface energy backing.

10) The photovoltaic device of claim 9, wherein the low surface energy backing decouples the frame from the sealant layer during thermocycling so that the sealant layer is prevented from cracking, being damaged, or both.

11) The photovoltaic device of claim 4, wherein the secondary layer is free of tack at room temperature.

12) The photovoltaic device of claim 2, wherein the sealant layer has a thickness of about 0.5 mm or more and preferably about 2.0 mm or more.

13) The photovoltaic device of claim 1, wherein the sealant material is resistant to shear so that the connector assembly is substantially free of current leakage, penetration by fluids, or both

14) The photovoltaic device of claim 1, wherein the connector assembly is laminated within the photovoltaic device.

15) The photovoltaic device of claim 3, wherein the acrylic foam is covered with a secondary layer on one or more sides.

16) The photovoltaic device of claim 15, wherein the one or more connector assemblies is free of a rigid case, is free of a separate case that connects over one or more layers of the one or more connector assemblies, or both.

17) The photovoltaic device of claim 16, wherein the sealant layer maintains geometry during a lamination process, an injection molding process, or both having a temperature of about 100° C. or more for a duration of about 15 minutes or more.

18) The photovoltaic device of claim 17, wherein the sealant layer has a fracture toughness of about 40 J/m² or more at temperatures ranging from about −40° C. to about 90° C. so that the sealant layer prevents cohesive separation of the frame, the secondary layer, or both during repeated thermal cycling.

19) The photovoltaic device of claim 18, wherein the acrylic foam is a cross-linked acrylic foam.

20) The photovoltaic device of claim 19, wherein the secondary layer is a low surface energy backing, and the low surface energy backing decouples the frame from the sealant layer during thermocycling so that the sealant layer is prevented from cracking, being damaged, or both.
